(19) United States
(12) Patent Application Publication
(10) Pub. No.: US 2012/0066002 A1
(43) Pub. Date: Mar. 15, 2012

(54) METHODS OF INITIATING CRITICAL ILLNESS INSURANCE

(76) Inventor: Andrew Jay Duckman, Toronto (CA)

(21) Appl. No.: 12/880,420

(22) Filed: Sep. 13, 2010

(51) Int. Cl. G06Q 40/00

(52) U.S. Cl. 705/4

(57) ABSTRACT

This invention provides a method of initiating a critical illness insurance policy, comprising: receiving from or on behalf of a person interested in both critical illness insurance and banking a biological sample (i) an agreement to enroll in a critical illness insurance policy, (ii) a biological sample, and (iii) one or more payments or an agreement to make one or more payments, and testing, having tested, or requesting testing of, the biological sample, thereby initiating the critical illness insurance policy.

### FIELD OF THE INVENTION

The present invention relates to methods of initiating a critical illness insurance policy involving the receipt of a biological sample.

### BACKGROUND OF THE INVENTION

Critical illness insurance is an insurance product wherein an insurance entity, such as an insurance provider, is contracted to make a payment, often a lump sum payment, to a policy holder (or some other beneficiary named in an insurance policy) if an individual named in the insurance policy (commonly referred to as the “insured”) becomes afflicted with a critical illness specified in the insurance policy.

The concept of critical illness insurance was borne out of an intention of providing financial protection to individuals following the diagnosis of an illness deemed critical. The motivation for the creation of this sort of insurance product was the financial status of many patients upon the diagnosis and treatment of a critical illness. Patients' financial resources can be threatened by decreased abilities to earn money needed to satisfy financial needs, and these financial issues often result in sacrifices, such as the need to sell their homes. These financial stresses often result in delayed or retarded recovery, and often exacerbate the patient's already compromised health. Life insurance policies do not relieving these stresses because they provide payment following the policy holder's death. Accordingly, the solution was the creation of critical illness insurance, providing financial support during the policy holder's lifetime with a payment (or payments) upon the diagnosis of critical illness. The payments can be used in any manner, including but not limited to paying for the costs of the care and treatment, repaying debts, replacing lost income due to a decreased ability to earn, or even funding a change in lifestyle.

The typical critical illness insurance policy is one where the insured is an individual irrespective of age. One type of critical illness insurance is child critical illness insurance, wherein the insured is a child (as defined in the policy). It is similar to the typical critical illness insurance (with the caveat the insured individual is a child). Such policies provide payment to the policy holder (or other named beneficiary) if the insured individual (typically the policy holder's child, or the policy holder's dependant) becomes afflicted with a critical illness specified in the insurance policy. The policy holder or beneficiary is typically entitled to spend the insurance benefit in any way he or she sees fit. Examples include but are not limited to helping the policy holder to cover lost income; enabling the policy holder to take time off from work to care for the child; helping the policy holder to pay for nursing care and/or medical equipment; and even helping the policy holder to pay for items unrelated to the child's critical illness. In short, it can provide the beneficiary with an ability to focus on the child's recovery and not on other financial concerns.

Biological deposit banking, such as cord blood banking, provides among other things, an opportunity to preserve stems cells from a baby's umbilical cord and placenta for possible therapeutic and/or medical use. Cord blood, which includes the blood remaining in the umbilical cord after the cord has been severed, is a good source of stem cells. Stem cells are typically genetically distinctive to a person and his or her family, and contribute to the development of all tissues, organs and systems in the body. Stem cells can transform into other types of cells in the body. This transformation can provide physicians and other medical practitioners with a means to treat certain diseases and disorders. Accordingly, banking a baby's blood and stem cells in a depository, such as a stem cell blood bank, provides a type of insurance. The deposited material could potentially be used to treat diseases and conditions of not only the child whose sample was deposited, but also others, such as family members including parents and siblings.

The invention described herein, among other things, helps to bridge enrollment in these two programs, i.e., critical illness insurance and biological sample banking For example, parents interested in banking their child's cord blood may also be interested in obtaining critical illness insurance for their child. Accordingly, the invention described herein provides, among other things, a more efficient system for providing critical illness insurance, for example, by identifying and enrolling persons interested in both depositing a biological sample (such as cord blood) and protecting against economic harm resulting from illness.

### SUMMARY OF THE INVENTION

This invention provides a method of initiating a critical illness insurance policy, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments, and
testing, having tested, or requesting testing of, the biological sample,
thereby initiating the critical illness insurance policy.

This invention provides a method of initiating a critical illness insurance policy, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments,
thereby initiating the critical illness insurance policy.

This invention provides a method of identifying a potential critical illness insurance purchaser, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments,
thereby identifying the potential critical illness insurance purchaser.

This invention provides a method of identifying a potential critical illness insurance purchaser, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments,
testing, having tested, or requesting testing of, the biological sample,
thereby identifying the potential critical illness insurance purchaser.

This invention provides a method of initiating a critical illness insurance policy comprising:

receiving from or on behalf of a person interested in both critical illness insurance and banking a biological sample (i) a biological sample, and (ii) one or more payments or an agreement to
make one or more payments,
testing, having tested, or requesting testing of, the biological sample,
receiving an authorization to initiate the critical illness insurance policy,
thereby initiating the critical illness insurance policy.

This invention provides a method of initiating a critical illness insurance policy comprising:

receiving from or on behalf of a person interested in both critical illness insurance and banking a biological sample (i) a biological sample, and (ii) one or more payments or an agreement to
make one or more payments,
receiving an authorization to initiate the critical illness insurance policy,
thereby initiating the critical illness insurance policy.

This invention provides a method of initiating a critical illness insurance policy comprising:

receiving from or on behalf of a person interested in both critical illness insurance and banking a biological sample, (i)) an agreement to enroll in a critical illness insurance policy, and (ii) one or
more payments or an agreement to make one or more payments, and
receiving confirmation that a biological sample has been deposited,
thereby initiating the critical illness insurance policy.

In one embodiment, the confirmation of the biological deposit is received from the person. In one embodiment, the confirmation is received from a biological sample bank.

### DETAILED DESCRIPTION OF THE PREFERRED EMBODIMENTS

This invention provides a method of initiating a critical illness insurance policy, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments, and
testing, having tested, or requesting testing of, the biological sample,
thereby initiating the critical illness insurance policy.

As used herein, “initiating” (as in the context of initiating a critical illness insurance policy) means collecting information directly or indirectly for the purpose of establishing an insurance policy.

As used herein, the singular forms “a,” “an,” and “the” include plural reference unless the context clearly dictates otherwise. Accordingly, the term “person interested in both critical illness insurance and banking a biological sample” may refer not only an individual person, but also to a two or more persons, such as a family of relatives, including but not limited to a married couple such as a husband and wife, parents, grandparents, and other families of relatives.

As used herein, “agreement to enroll” means an indication of interest subject to final acceptance by an insurer.

In the invention described herein, it is understood the steps recited in the claims need not be performed in the order recited, but rather may be performed in any order and/or concurrently with one another. Accordingly, for example, the step of receiving the various items, and testing the biological sample, need not be performed in the order recited, but rather may be performed in any order and/or concurrently with one another. Accordingly, it is understood that a claim embraces any order of the recited steps and/or receipt of the items. For example, items (i), (ii) and (iii) may be received in another order and/or concurrently with one or more of each other. Also for example, the testing, having tested or requesting step may be performed before, after, or concurrently with receipt of any of any of the items, such as items (i), (ii) and (iii), with the understanding that the biological sample must be received before it is tested. In this invention, the steps of receiving any of the various items, and testing the biological sample, may also be performed concurrently.

A critical illness insurance policy typically requires payment or payments to a beneficiary named in the policy if the insured is afflicted with a critical illness named in the policy. Typically, the policy must be in effect for a payment to be required. The critical illnesses named in the policy are commonly referred to as covered critical illnesses. Typically upon the diagnosis of the critical illness, a claim must be filed within certain time frames. For example, some policies require that the claim be filed while the policy is in effect and within one year of the diagnosis of the critical illness. However, this invention would apply to any type of critical illness policy known to those skilled in the art. The claim procedures, payment requirements, and other specifics are typically provided in the policy or other related materials.

The types of critical illness insurance policies contemplated by this invention may be of any type known to those skilled in the art. For example, in one embodiment, the insurance policy is one that is not medically underwritten. In another embodiment, the insurance policy is one that is medically underwritten. In the event that the policy is medically underwritten, one or more additional steps may be needed in order to initiate the policy.

In the invention described herein, the insurance policy can be initiated by various types of persons, agencies, institutions, companies and the like. Examples include but are not limited to insurance companies and biological sample banks.

Examples of insurance companies include but are not limited to any type of institution known to those skilled in the art that are in the insurance business, including but not limited to insurance providers, insurance underwriters, and reinsurers.

Examples of biological sample banks, sometimes also referred to as depositories, include but are not limited to any type of institution known to those skilled in the art that receives and stores biological samples. There are typically two types of depositories: public depositories, wherein the sample is donated anonymously for potential use by a patient in need; and private depositories, wherein the sample is stored for the exclusive use of the depositor and his or her family. In a preferred embodiment, the invention relates to private depositories. Biological sample banks, upon receipt of the sample, typically process the sample, which often includes testing and preservation of the sample, prior to storage. The biological sample banks encompassed by the invention described herein include any biological sample bank or depository known to those skilled in the art. Examples of such depositories include those run by Cord Blood Registry® (CBR), Viacord, Viacell, AlphaCord, Assurelmmune™, CordBancUSA™, Cord Blood America, Cord Blood Solutions, Cryobanks International, Cryo-Cell International, DomaniCell, Elie Katz, Family CB Services, Genesis Bank, HemaStem, LifebankUSA, LifeLine, MAZE Labs, Neocells, Newborn Blood Banking, PacifiCord, Securacell, StemCyte, Stork Medical, Utah Cord Bank, Vista Cord, Xytex, CReATe Cord Blood, Healthcord Cryogenics Corp., HemaStem Therapaeutics, Insception Biosciences, Lifebank Cryogenics Corp., Progenics Cryobank, and Stem Sciences, Inc. In one embodiment of the invention described herein, the depository is a stem cell blood bank. In one embodiment, the stem cell blood bank is a cord blood stem cell blood bank.

In one embodiment of the invention described herein, the critical illness insurance policy is initiated by a biological sample bank. Such would include a scenario where the biological sample bank has the authority to bind coverage. In one embodiment, the critical illness insurance policy that is initiated by the biological sample bank is not medically underwritten. In another embodiment, the critical illness insurance policy is medically underwritten.

In another embodiment of the invention described herein, the biological sample bank initiates the critical illness insurance policy on behalf of an insurance company. Such would include a scenario where the biological sample bank does not have the authority to bind coverage, but can do so, for instance, at or under the direction of the insurance company. In one embodiment, the critical illness insurance policy that is initiated by the biological sample bank is not medically underwritten. In another embodiment, the critical illness insurance policy that is initiated by the biological sample bank is medically underwritten.

In another embodiment of the invention described herein, the biological sample bank that initiates the critical illness insurance policy is also an insurance company. Such would include a scenario where the biological sample bank provides insurance services and/or is also in the insurance business. Such would also include a scenario where the biological bank is an affiliate of an insurance company. Such would also include a parent-subsidiary relationship. In one embodiment, the critical illness insurance policy that is initiated by the biological sample bank is not medically underwritten. In another embodiment, the critical illness insurance policy that is initiated by the biological sample bank is medically underwritten.

In one embodiment of the invention described herein, the critical illness insurance policy is initiated by an insurance company. In one embodiment, the critical illness insurance policy is initiated by an insurance company that also provides biological sample banking services. Such would also include a scenario where the insurance company is an affiliate or other related entity of a biological sample bank. Such would also include a parent-subsidiary relationship. In one embodiment, the critical illness insurance policy that is initiated by the insurance company is not medically underwritten. In another embodiment, the critical illness insurance policy that is initiated by the insurance company is medically underwritten.

The invention described herein relates to critical illness insurance. That is, the insured for the critical illness insurance could be any individual irrespective of age. In one embodiment, the critical illness insurance policy is a child critical illness insurance policy. In other words, the insured individual for the policy is a child. The definition of child would be known to those skilled in the art and is typically clarified or defined in the critical illness insurance policy. In one embodiment, a child is typically considered any individual who is not yet eighteen years old. In another embodiment, the insured individual for the policy is an adult. In one embodiment, an adult is typically considered any individual who is at least eighteen years old.

In one embodiment of the invention described herein, the biological sample may be one that is collected from the insured individual named in the critical illness insurance policy. In other words, the source of the biological sample is the same person as the insured person in the critical illness insurance policy. Or in other words, to further clarify the meaning of source in this context, the blood or cells (or other type of sample known to those skilled in the art) are those of the insured person. For example, a parent decides to bank the biological sample of his or her child, and also obtain critical illness insurance naming his or her child as the insured. In another example, a person decides to bank his or her own biological sample, and also obtain critical illness insurance naming himself or herself as the insured.

In one embodiment of the invention described herein, the biological sample is collected from a family member of an insured individual named in the critical illness insurance policy. In other words, the source of the biological sample is a family member of an insured individual named in the insurance policy. Or in other words, to further clarify the meaning of source in this context, the blood or cells (or other type of sample known to those skilled in the art) are those of a family member of the insured person.

In one embodiment, the family member is the insured individual's child. In other words, the biological sample is collected from the child of the insured individual. Or in other words, a parent decides to bank his or her child's biological sample, and also obtain critical illness insurance naming himself or herself as the insured.

In one embodiment, the family member is the insured individual's parent. In other words, the biological sample is collected from the parent of the insured individual. Or in other words, a parent decided to bank his or her own biological sample, and also obtain critical illness insurance naming his or her child as the insured.

In one embodiment of the invention described herein, the testing comprises testing for viability.

In one embodiment of the invention described herein, the testing comprises testing for an infectious agent. The infectious agents tested for are well known to those skilled in the art. In one embodiment, the infectious agent is a virus. Examples of viruses include, but are not limited to, the following DNA and RNA viral families: Arbovirus, Adenoviridae, Arenaviridae, Arterivirus, Birnviridae, Bunyaviridae, Caliciviridae, Circoviridae, Coronaviridae, Flaviviridae, Hepadnaviridae (Hepatitis), Herpesviridae (such as Cytomegalovirus, Herpes Simplex, Herpes Zoster), Mononegavirus (e.g., Paramyxoviridae, Morbillivirus, Rhabdoviridae), Orthomyxoviridae (e.g., Influenza), Papovaviridae, Parvoviridae, Picomaviridae, Poxyiridae (such as Smallpox or Vaccinia), Reoviridae (e.g., Rotavirus), Retroviridae (HTLV-I, HTLV-II, Lentivirus), and Togaviridae (e.g., Rubivirus).

In one embodiment, the infectious agent is a bacterial or fungal agent. Examples include but are not limited to, the following Gram-Negative and Gram-positive bacterial families and fungi: Actinomycetales (e.g., Corynebacterium, Mycobacterium, Norcardia), Aspergillosis, Bacillaceae (e.g., Anthrax, Clostridium), Bacteroidaceae, Blastomycosis, Bordetella, Borrelia, Brucellosis, Candidiasis, Campylobacter, Coccidioidomycosis, Cryptococcosis, Dermatocycoses, Enterobacteriaceae (Klebsielia, Salmonella, Serratia, Yersinia), Erysipelothrix, Helicobacter, Legionellosis, Leptospirosis, Listeria, Mycoplasmatales, Neisseriaceae (e.g., Acinetobacter, Gonorrhea, Menigococcal), Pasteurellacea infections (e.g., Actinobacillus, Heamophilus, Pasteurella), Pseudomonas, Rickettsiaceae, Chlamydiaceae, Syphilis, and Staphylococcus.

In another embodiment, the infectious agent is a prion. In another embodiment, the infectious agent is a parasitic agent. Examples of such parasitic agents include, but are not limited to, the following families: Amebiasis, Babesiosis, Coccidiosis, Cryptosporidiosis, Dientamoebiasis, Dourine, Ectoparasitic, Giardiasis, Helminthiasis, Leishmaniasis, Theileriasis, Toxoplasmosis, Trypanosomiasis, and Trichomoniasis.

In one embodiment of the invention described herein, the testing comprises a test for genetic stability. In another embodiment of the invention described herein, the testing comprises a test for a genetic mutation.

In one embodiment of the invention described herein, the biological sample is collected from a child of the person interested in both critical illness insurance and banking a biological sample. In other words, the source of the biological sample is a child of the person interested in both critical illness insurance and banking a biological sample. Or in other words, to further clarify the meaning of source in this context, the blood or cells (or other type of sample known to those skilled in the art) are those of the a child of the person interested in both critical illness insurance and banking a biological sample. In a preferred embodiment, the child is a newborn, and the biological sample is collected during or shortly after the birth of the newborn.

In one embodiment of the invention described herein, the biological sample is collected from a dependant of the person interested in both critical illness insurance and banking a biological sample. In other words, the source of the biological sample is a dependant of the person interested in both critical illness insurance and banking a biological sample. Or in other words, to further clarify the meaning of source in this context, the blood or cells (or other type of sample known to those skilled in the art) are those of the a dependant of the person interested in both critical illness insurance and banking a biological sample.

Methods of collecting the biological samples described herein, including but not limited to cord blood and stem cells, are well known to those skilled in the art. The literature is replete with the teachings of such methodology, including the following: Singh et al., Cytotherapy. 2009 April 28: 1-10 (Evaluation of four methods for processing human cord blood and subsequent study of the expansion of progenitor stem cells isolated using the best method); Papassavas et al., Int J Lab Hematol. 2008 April; 30 (2): 124-32 (A strategy of splitting individual high volume cord blood units into two half subunits prior to processing increases the recovery of cells and facilitates ex vivo expansion of the infused haematopoietic progenitor cells in adults); Watt et al., Methods Mol Biol. 2007; 368: 237-59 (Cryopreservation of hematopoietic stem/progenitor cells for therapeutic use); Novelo-Garza et al., Transfusion. 2008 February; 48 (2): 228-36 (Establishing a cord blood banking and transplantation program in Mexico: a single institution experience); Friedman et al., Biol Blood Marrow Transplant. 2007 December; 13 (12): 1477-86 (Umbilical cord mesenchymal stem cells: adjuvants for human cell transplantation); Koliakos et al., Cytotherapy. 2007; 9 (7): 654-9 (A novel high-yield volume-reduction method for the cryopreservation of UC blood units); George et al.,Transfusion. 2006 October; 46 (10): 1803-12 (Factors associated with parameters of engraftment potential of umbilical cord blood); Bornstein et al., Stem Cells. 2005 March; 23 (3): 324-34 (A modified cord blood collection method achieves sufficient cell levels for transplantation in most adult patients); U-pratya et al., J Med Assoc Thai. 2003 November; 86 (11): 1055-62 (Collection and processing of umbilical cord blood for cryopreservation); Hubel et al., Cytotherapy. 2003; 5 (5): 370-6 (Cryopreservation of cord blood after liquid storage); Meyer et al., Cytotherapy. 2006; 8 (3): 265-76 (Analysis and cryopreservation of hematopoietic stem and progenitor cells from umbilical cord blood); Donaldson et al., Bone Marrow Transplant. 1996 October; 18 (4): 725-31 (Optimal cryopreservation of human umbilical cord blood).

The invention described herein contemplates that testing occur at any time prior to diagnosis of a critical illness. In a preferred embodiment, the testing begins shortly after receipt of the biological sample. For example, testing may begin immediately upon receipt. In other embodiment, testing may begin within 24 hours or alternatively within 48 hours of receipt. Preferably, testing begins within one week of receipt of the sample. However, this invention encompasses situations where testing begins more than one week after receipt. One skilled in the art would know the time frames within which the testing should commence.

In the invention described herein, the biological sample received may be of any type known to those skilled in the art. In one embodiment, the biological sample is a cord blood sample. In one embodiment, the biological sample is a bone marrow sample. In one embodiment, the biological sample comprises stem cells. In one embodiment, the biological sample comprises placental cells. In one embodiment, the biological sample comprises human umbilical vein endothelial cells, commonly also known as HUVEC cells.

In one embodiment of the invention described herein, the critical illness is any illness, disease or disorder recited in the critical illness insurance policy. Examples of critical illnesses include but are not limited to diabetes mellitus, congenital heart disease, cerebal palsy, cystic fibrosis, muscular dystrophy, cancer, heart attack, stroke, coronary artery bypass surgery, aplastic anemia, bacterial meningitis, aortic surgery, heart valve replacement, loss of speech, kidney failure, major organ transplant, major organ failure on waiting list, blindness, deafness, occupational HIV infection, coma, benign brain tumor, paralysis, loss of limbs, severe burns, multiple sclerosis, alzheimer's disease, parkinson's disease, motor neuron disease, ductal carcinoma in situ of the breast, stage 1A malignant melanoma, stage A (T1a or T1b) prostate cancer, autism, asperger syndrome, pervasive developmental disorder not otherwise specified (PDD-NOS), rett syndrome, and coronary angioplasty. Examples of critical illnesses include but are not limited to those characterized as genetic disease, metabolic disease, autoimmune disease, central nervous system disorder, neurodegenerative disease, and cancer. In a preferred embodiment, the critical illness is diabetes mellitus. In another preferred embodiment, the critical illness is congenital heart disease. In another preferred embodiment, the critical illness is cerebral palsy. In another preferred embodiment, the critical illness is cystic fibrosis. In another preferred embodiment, the critical illness is muscular dystrophy.

In one embodiment of the invention described herein, at least a portion of the payment or payments received from or on behalf of a person interested in both critical illness insurance and banking a biological sample is a premium payment for the critical insurance policy.

This invention provides a method of identifying a potential critical illness insurance purchaser, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments, thereby identifying the potential the critical illness insurance purchaser.

In one embodiment, the potential critical illness insurance purchaser is identified for or on behalf of an insurance company. In one embodiment, the potential purchaser is also the potentially insured person. In one embodiment, the potential purchaser is not the potentially insured person (such embodiment includes but is not limited to, a parent purchasing critical illness insurance for his or her child).

This invention provides a method of identifying a potential critical illness insurance purchaser, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments,
testing, having tested, or requesting testing of, the biological sample,
thereby identifying the potential critical illness insurance purchaser.
In one embodiment, the potential critical illness insurance purchaser is identified for or on behalf of an insurance company. In one embodiment, the potential purchaser is also the potentially insured person. In one embodiment, the potential purchaser is not the potentially insured person (such embodiment includes but is not limited to, a parent purchasing critical illness insurance for his or her child).

This invention provides a method of initiating a critical illness insurance policy, comprising:

receiving from or on behalf of a person interested in both critical illness insurance and banking a biological sample (i) an agreement to enroll in a critical illness insurance policy, (ii) a biological sample, and (iii) one or more payments or an agreement to make one or more payments,
thereby initiating the critical illness insurance policy.

This invention provides a method of initiating a critical illness insurance policy comprising:

receiving from or on behalf of a person interested in both critical illness insurance and banking a biological sample (i) a biological sample, and (ii) one or more payments or an agreement to make one or more payments,
testing, having tested, or requesting testing of, the biological sample,
receiving an authorization to initiate the critical illness insurance policy,
thereby initiating the critical illness insurance policy.
In one embodiment, the authorization is received from an insurance company.

This invention provides a method of initiating a critical illness insurance policy comprising:

receiving from or on behalf of a person interested in both critical illness insurance and banking a biological sample (i) a biological sample, and (ii) one or more payments or an agreement to make one or more payments,
receiving an authorization to initiate the critical illness insurance policy,
thereby initiating the critical illness insurance policy.
In one embodiment, the authorization is received from an insurance company.

This invention provides a method of initiating a critical illness insurance policy comprising:

receiving from or on behalf of a person interested in both critical illness insurance and banking a biological sample, (i)) an agreement to enroll in a critical illness insurance policy, and (ii) one or more payments or an agreement to make one or more payments, and
receiving confirmation that a biological sample has been deposited,
thereby initiating the critical illness insurance policy.
In one embodiment, the confirmation of the biological deposit is received from the person. In embodiment, the confirmation is received from a biological sample bank.

One embodiment of the invention described herein comprises two categories of requsted information: (i) information for submitting the biological sample to the depository (also referred to herein as the Deposit Information); and (ii) information for enrolling in the critical illness insurance policy (also referred to herein as the Insurance Information).

One skilled in the art of biological deposits would be familiar with the typical Deposit Information and the sorts of questions and information that might be requested. For example, when depositing cord blood, the following are examples of questions/information that may be (but are not necessarily) asked: (i) whether the biological mother is in good general health, (ii) whether the biological mother is taking is taking an antibiotic, (iii) whether the biological mother or father has been diagnosed or exposed to tuberculosis, (iv) whether the biological mother or father has been exposed to, or had sexual contact with someone who has hepatitis, (v) whether the biological mother or father has had sexual contact with someone who is HIV positive, (vi) whether the biological mother has been diagnosed with a sexually transmitted disease within the past year, (vii) whether the biological mother has had a blood transfusion or tissue graft within the past year, (viii) whether the biological mother has been vaccinated within the past several months, (ix) whether the biological mother has been in contact with someone who has been vaccinated with smallpox within the past several months, (x) whether either the biological mother or father has tested positive for HIV, sexually transmitted disease such as syphilis, hepatitis B, or hepatitis C, (xi) whether either the biological mother or father has taken drugs not prescribed by a doctor by hypodermic needle, (xii) contact information for the mother and father, (xiii) baby's expected due date, and (xiv) name and contact information for the obstetrician/midwife.

Moreover, one skilled in the art of critical insurance would be familiar the typical Insurance Information. The Insurance Information can be of any form envisioned by those skilled in the art. For example, the Insurance Information may contain a box to be checked or otherwise marked, indicating an agreement to enroll in the critical illness insurance. The act of checking or otherwise marking the box, or providing some other indication envisioned by those skilled in the art, could constitute an agreement to enroll in the critical illness insurance. In another embodiment, the Insurance Information may be more detailed and ask certain medically oriented questions, such as concerning the medical history of the insured and/or the insured's family. One skilled in the art of critical insurance would be familiar with the sorts of questions and information that might be requested. For example, the following are examples of questions/information that may be (but are not necessarily) asked: (1) if the proposed insured is younger than a certain age specified in the policy (in some embodiments, such age is 16 years old) then the following questions may be asked (i) whether any of the proposed insured's biological parents, siblings, or grandparents have ever been afflicted with heart disease, heart attack high blood pressure, stroke, familial hyperlipidemia, diabetes, cancer, kidney disease, multiple sclerosis, parkinson's disease, amyotrophic lateral sclerosis (ALS), alzheimer's disease, muscular dystrophy or other motor neuron disease, polycystic kidney disease, retinitis pigmentosa, huntigton's chorea, or other genetic disorders; (ii) whether the proposed insured has been tested for exposure to HIV, or been treated for or had any indication of HIV or other immune disease; and (iii) whether the proposed insured has been treated for or had any indication of heart murmur, heart disease, diabetes, elevated blood sugar, thyroid or other endocrine disorder, hemophilia or other bleeding disorder, cancer, kidney disease, hepatitis or liver disorder, epilepsy, multiple sclerosis, down syndrome, mental retardation, cerebral palsy, muscular dystrophy or other congenital nervous system disorder, cystic fibrosis, asthma, blindness or deafness. (2) If the proposed insured is older then a certain age specified in the policy (in some embodiments, such age is 16 years old) then the following questions might be (but are not necessarily) asked: whether the proposed insured has ever been treated for or had any indication of heart murmur or irregular heart beat or irregular pulse, heart attack, chest pain, coronary artery disease or other heart disease, hypertension, elevated cholesterol, stroke, aneurysm, diabetes, high blood sugar, goiter, thyroid or endocrine disorders, hemophilia or bleeding disorders, cancer, hepatitis or lover disorders, kidney disease, epilepsy, alzheimer's disease, parkinson's disease, amyotrophic lateral sclerosis, cerebral palsy, ulcers, colitis, crohn's disease, depression, anxiety, or abnormal x-rays, scans, biopsies, MRI, blood tests or other diagnostics.

In one embodiment, the Deposit Information and the Insurance Information are in paper form. In one embodiment, the Deposit Information and Insurance Information accompany each other. In one embodiment, the Deposit Information is contained in or on the same page as the Insurance Information. In one embodiment, the Deposit Information is contained on a separate but attached page as the Insurance Information. In one embodiment, the Deposit Information is contained on an accompanying page as the Insurance Information, such as contained in the same information packet.

In one embodiment of the invention described herein, the Insurance Information and/or the Deposit Information may be completed and/or submitted electronically or via other means that do not require actual paper, such as via the internet, on-line, world wide web, smart phone, telephone, orally, and other non-paper means known to those skilled in the art.

All publications, patents and/or patent applications mentioned herein are hereby incorporated by reference in their entirety as if each individual publication, patent or patent applications was specifically and individually indicated to be incorporated by reference. In case of conflict, the present application, including any definitions herein, will control.

It will be further understood that there are details of the present disclosure which may be changed without departing from the scope of the invention. The foregoing description is for the purpose of illustration only and not for the purpose of limitation.

1. A method of initiating a critical illness insurance policy, comprising:
receiving from or on behalf of a person interested in both critical illness insurance and banking a biological sample (i) an agreement to enroll in a critical illness insurance policy, (ii) a viable biological sample, and (iii) one or more payments or an agreement to make one or more payments, and testing, having tested, or requesting testing of, the biological sample, thereby initiating the critical illness insurance policy.

2. The method of claim 1, wherein the critical illness insurance policy is initiated by a biological sample bank.

3. The method of claim 2, wherein the biological sample bank initiates the critical illness insurance policy on behalf of an insurance company.

4. The method of claim 2, wherein the biological sample bank is also an insurance company.

5. The method of claim 1, wherein the critical illness insurance policy is initiated by an insurance company.

6. The method of claim 5, wherein the insurance company is also a biological sample bank.

7. The method of claim 1, wherein the critical illness insurance policy is a child critical illness insurance policy.

8. The method of claim 1, wherein the biological sample is collected from an insured individual named in the critical illness insurance policy.

9. The method of claim 1, wherein the biological sample is collected from a family member of an insured individual named in the critical illness insurance policy.

10. The method of claim 9, wherein the family member is the insured individual's child.

11. The method of claim 9, wherein the family member is the insured individual's parent.

12. The method of claim 1, wherein the testing comprises testing for viability.

13. The method of claim 1, wherein the testing comprises testing for an infectious agent.

14. The method of claim 13, wherein the infectious agent is selected from the group consisting of virus, bacteria, fungi, and prions.

15. The method of claim 1, wherein the testing comprises a test for genetic stability.

16. The method of claim 1, wherein biological sample is obtained from a child of the person interested in both critical illness insurance and banking a biological sample.

17. The method of claim 1, wherein biological sample is obtained from a dependant of the person interested in both critical illness insurance and banking a biological sample.

18. The method of claim 1, wherein the testing occurs at any time prior to diagnosis of a critical illness.

19. The method of claim 1, wherein the biological sample is a cord blood sample.

20. The method of claim 1, wherein at least a portion of the payment or payments is a premium payment for the critical insurance policy.
